(19) United States
(12) Patent Application Publication
(10) Pub. No.: US 2016/0282667 A1
(43) Pub. Date: Sep. 29, 2016

(54) COLOR LIQUID CRYSTAL DISPLAY MODULE STRUCTURE AND BACKLIGHT MODULE THEREOF

(71) Applicant: Shenzhen Chine Star Optoelectronics Technology Co., Ltd., Shenzhen, Guangdong (CN)

(72) Inventor: Yong FAN, Shenzhen, Guangdong (CN)

(73) Assignee: Shenzhen Chine Star Optoelectronics Technology Co., Ltd., Shenzheng, Guangdong (CN)

(21) Appl. No.: 14/426,985

(22) PCT Filed: Sep. 11, 2014
(86) PCT No.: PCT/CN2014/086262

§ 371 Date: Mar. 9, 2015

(30) Foreign Application Priority Data
Aug. 20, 2014 (CN) 201410415864.X

(51) Int. Cl. G02F 1/1335; G02F 1/1368; F21V 8/00

(52) U.S. Cl. CPC G02F 1/133514; G02B 6/005; G02B 6/0055; G02B 6/0073; G02F 1/1368; G02B 6/0023

(57) ABSTRACT

The present invention provides a color liquid crystal display module structure and a backlight module thereof. The color liquid crystal display module structure includes a backlight module (1) and a liquid crystal display panel (3). The liquid crystal display panel (3) includes a CF substrate (33). The CF substrate (33) includes a plurality of alternately arranged yellow color filter units (331) and blue color filter units (333). The liquid crystal display panel (3) includes a plurality of pixels arranged in a matrix form. Each of the pixels includes two sub-pixels. The sub-pixels respectively correspond to the yellow and blue color filter units (331, 333). The backlight module (1) includes an LED light source (13). The LED light source (13) includes a plurality of alternately arranged first LED lights (131) and second LED lights (133). The first LED lights (131) use a blue chip in combination with green phosphor packaging and the second LED lights (133) use a blue chip in combination with red phosphor packaging. The first and second LED lights (131, 133) are alternately lit to respectively make up first and second color fields.

### BACKGROUND OF THE INVENTION

1. Field of the Invention

The present invention relates to the field of display technology, and in particular to a color liquid crystal display module structure and a backlight module thereof.

2. The Related Arts

Liquid crystal displays (LCDs) have a variety of advantages, such as thin device body, low power consumption, and being free of radiation, and are thus of wide applications, such as liquid crystal televisions, mobile phones, personal digital assistants (PDAs), digital cameras, computer monitors, and notebook computer screens.

Most of the liquid crystal displays that are currently available in the market are backlighting liquid crystal displays, which comprise an enclosure, a liquid crystal display panel arranged in the enclosure, and a backlight module mounted in the enclosure.

Referring to FIG. 1, a structure of a liquid crystal display panel that is commonly seen nowadays is composed of a color filter (CF) substrate 100, a thin-film transistor (TFT) array substrate 200, and a liquid crystal layer 300 arranged between the two substrates and the principle of operation is that a driving voltage is applied to the two glass substrates to control rotation of the liquid crystal molecules of the liquid crystal layer in order to refract out light emitting from the backlight module for generating images. The liquid crystal display panel comprises a plurality of pixels that is arranged in a matrix form. Each of the pixels comprises sub-pixels of red, green, and blue colors. The three sub-pixels of red, green, and blue respectively correspond to a red color filter unit 101, a green color filter unit 103, and a blue color filter unit 105 of the CF substrate 100.

The backlight modules can be classified in two types, namely a side-edge backlight module and a direct backlight module, according to the site where light gets incident. The direct backlight module comprises a light source, such as a cold cathode fluorescent lamp (CCFL) or a light-emitting diode (LED), which is arranged at the backside of the liquid crystal panel so that light passes through and is homogenized by a diffusion board to form a planar light source supplied to the liquid crystal panel. The side-edge backlight module comprises an LED light bar, serving as a backlight source, which is arranged at an edge of a backplane to be located rearward of one side of the liquid crystal panel. The LED light bar emits light that enters a light guide plate (LGP) through a light incident face at one side of the light guide plate and is projected out of a light emergence face of the light guide plate, after being reflected and diffused, to pass through an optic film assembly so as to form a planar light source for the liquid crystal panel.

With the progress of the displaying technology, it is now an important direction of development of the display devices to achieve high resolution and high color gamut. For the liquid crystal displays, a general solution adopted in the known techniques to achieve high color gamut is using an LED composed a blue light emission chip packaged with red and green phosphors as a backlight source, which is used in combination with an increased thickness of the color filter. However, in the LED that is composed of a blue light emission chip packaged with red and green phosphors, besides being excited to emit red light by absorbing blue light, the red phosphor also absorbs a minor amount of green light, but the efficiency that red light is excited by the green light is extremely low, thereby making the brightness of the LED that is composed of a blue light emission chip packaged with red and green phosphors lowered down.

### SUMMARY OF THE INVENTION

An object of the present invention is to provide a color liquid crystal display module structure, wherein the structure has an higher aperture ratio and a higher light transmission rate so as to provide the liquid crystal display module with high resolution, high gamut, and high efficiency and also to improve the productivity of the liquid crystal display module.

Another object of the present invention is to provide a backlight module, which allows a color liquid crystal display module to perform two field sequential displaying and to improve the efficiency of an LED light and prevent problems of inconsistency of driving voltage and reduction of lifespan of the LED light.

To achieve the above object, firstly, the present invention provides a color liquid crystal display module structure, which comprises a backlight module and a liquid crystal display panel arranged above the backlight module. The liquid crystal display panel comprises a color filter (CF) substrate. The CF substrate comprises a plurality of alternately arranged yellow color filter units and blue color filter units. The liquid crystal display panel comprises a plurality of pixels arranged in a matrix form. Each of the pixels comprises two sub-pixels. The sub-pixels respectively correspond to the yellow and blue color filter units. The backlight module comprises a light-emitting diode (LED) light source. The LED light source comprises a plurality of alternately arranged first LED lights and second LED lights. The first LED lights each use a blue chip in combination with green phosphor packaging. The second LED lights each use a blue chip in combination with red phosphor packaging. The first and second LED lights are alternately lit.

When the first LED lights are lit and the second LED lights are shut down, lights transmitting through the yellow blue color filter units are respectively green light and blue light, which make up a first color field; and when the second LED lights are lit and the first LED lights are shut down, lights transmitting through the yellow and blue color filter units are respectively red light and blue light, which make up a second color field; and the first and second color fields are mixable to achieve displaying an image with full color.

Each of the first LED lights is spaced from one of the second LED lights that is adjacent thereto by a spacing distance L that is smaller than or equal to 12 mm.

The backlight module further comprises a light guide plate, an optical film assembly arranged on an upper surface of the light guide plate, and a bottom reflector plate arranged on a lower surface of the light guide plate. The LED light source is arranged at one side of the light guide plate.

An optical light mixture assembly is arranged between the light guide plate and the LED light source.

The liquid crystal display panel further comprises a thin-film transistor (TFT) substrate arranged below the CF substrate and a liquid crystal layer arranged between the TFT substrate and the CF substrate.

The present invention also provides a backlight module, which comprises a light-emitting diode (LED) light source. The LED light source comprises a plurality of alternately arranged first LED lights and second LED lights. The first LED lights use a blue chip in combination with green phosphor packaging. The second LED lights use a blue chip in combination with red phosphor packaging. The first and second LED lights are alternately lit.

Each of the first LED lights is spaced from one of the second LED lights that is adjacent thereto by a spacing distance L that is smaller than or equal to 12 mm.

The backlight module further comprises a light guide plate, an optical film assembly arranged on an upper surface of the light guide plate, and a bottom reflector plate arranged on a lower surface of the light guide plate. The LED light source is arranged at one side of the light guide plate.

An optical light mixture assembly is arranged between the light guide plate and the LED light source.

The efficacy of the present invention is that the present invention provides a color liquid crystal display module structure, which has pixels each comprise two sub-pixels. The sub-pixels respectively correspond to yellow and blue color filter units of a CF substrate. An LED light source comprises a plurality of alternately arranged first LED lights and second LED lights, so that when the first LED lights are lit and the second LED lights are shut down, green and blue lights are emitted to make up a first color field; and when the second LED lights are lit and the first LED lights are shut down, red and blue lights are emitted to make up a second color field. The first and second color fields are mixable to achieve displaying an image in full color. Further, the aperture ratio is made greater and the light transmission rate is increased so that the liquid crystal display module has high resolution, high gamut, and high efficiency and the productivity of liquid crystal display module can be enhanced. The present invention provides a backlight module, which comprises an LED light source that comprises a plurality of alternately arranged first LED lights that use a blue chip in combination with green phosphor packaging and second LED lights that use a blue chip in combination with red phosphor packaging. The first and second LED lights are lit alternately to allow a color liquid crystal display module to achieve two field sequential displaying thereby increasing the efficiency of the LED lights and preventing the problems of inconsistency of driving voltage and inconsistent deterioration of lifespan of the LED lights.

For better understanding of the features and technical contents of the present invention, reference will be made to the following detailed description of the present invention and the attached drawings. However, the drawings are provided for the purposes of reference and illustration and are not intended to impose limitations to the present invention.

### BRIEF DESCRIPTION OF THE DRAWINGS

The technical solution, as well as other beneficial advantages, of the present invention will be apparent from the following detailed description of embodiments of the present invention, with reference to the attached drawing. In the drawing:

FIG. 1 is a cross-sectional view showing a conventional structure of a liquid crystal panel;

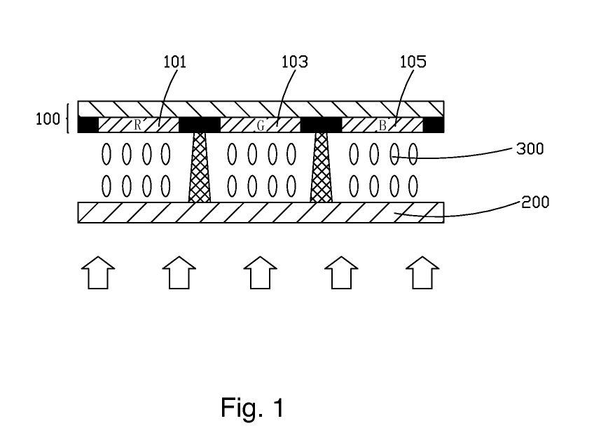

FIG. 2 is a cross-sectional view showing a color liquid crystal display module structure and a backlight module according to the present invention; and

FIG. 3 is a top plan view showing the color liquid crystal display module structure and an LED light source, a light guide plate, and an optical light mixture assembly of the backlight module according to the present invention.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

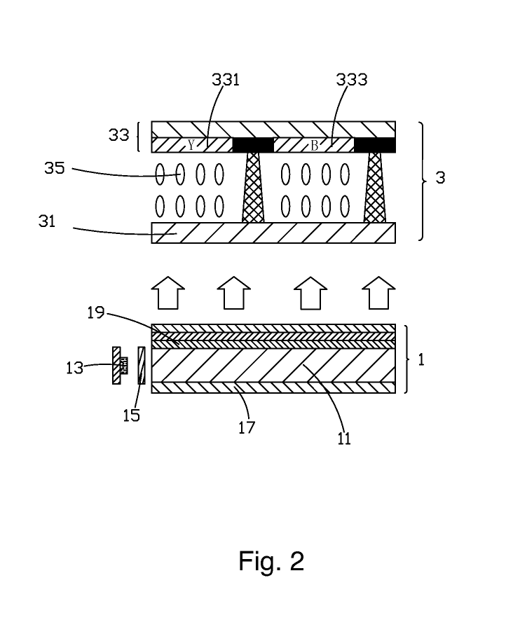

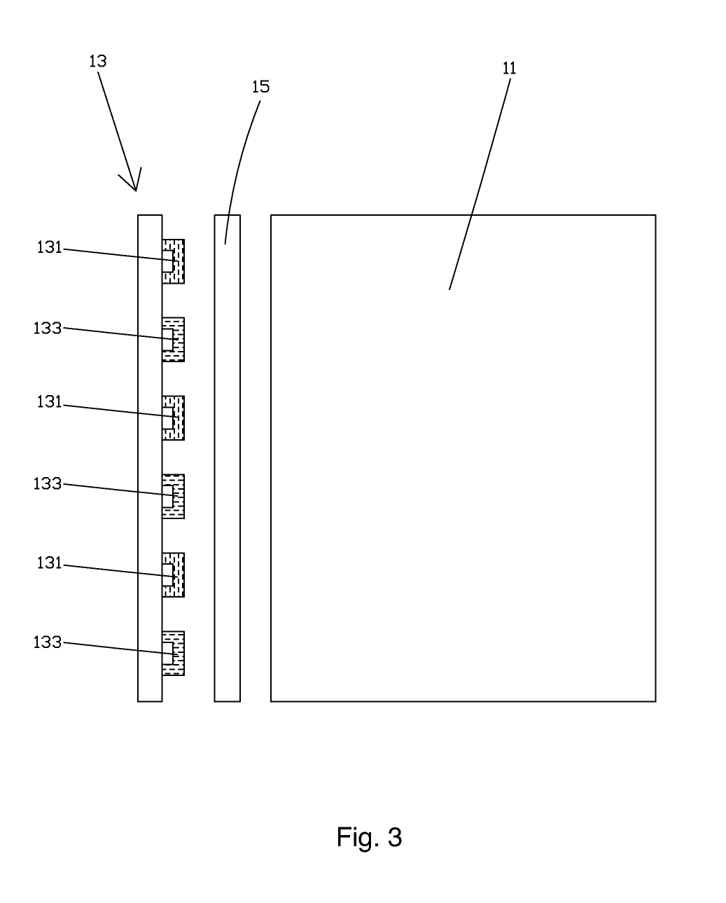

Referring to FIGS. 2 and 3, the present invention provides a color liquid crystal display module structure. The color liquid crystal display module structure is a two field sequential color liquid crystal display module structure.

The so-called “field sequential color liquid crystal display (FSC-LCD) module” is a liquid crystal display module that has high resolution and high color saturation, which displays image messages of three colors of red, green, and blue on a liquid crystal display panel in a time division manner and makes use of visual persistence of human eyes to form a color image, making it passible to achieve a higher pixel density in a unit displaying area. Namely, an image is divided into a plurality of sub color fields and sub-images of red, green, and blue are sequentially displayed so that through visual persistence of human eyes, a color image can be displayed on the eye retinas through accumulation and addition of the three primary colors by application of time color mixing whereby light transmission rate can be greatly raised and the aperture ratio of pixels is increased to enhance the resolution and color saturation of a displayed image.

The color liquid crystal display module structure according to the present invention comprises two color fields and an image of full color can be displayed through mixture of the two color fields. As shown in FIG. 2, the color liquid crystal display module structure comprises a backlight module 1 and a liquid crystal display panel 3 arranged above the backlight module 1.

The liquid crystal display panel 3 comprises a color filter (CF) substrate 33, a thin-film transistor (TFT) substrate 31 arranged below the CF substrate 33, and a liquid crystal layer 35 arranged between the TFT substrate 31 and the CF substrate 33.

The CF substrate 33 comprises a plurality of alternately arranged yellow color filter units (Yellow CF, Y CF) 331 and blue color filter units (Blue CF, B CF) 333. The liquid crystal display panel 3 comprises a plurality of pixels arranged in a matrix form. Each of the pixels comprises two sub-pixels and the sub-pixels respectively correspond to the yellow and blue color filter units 331, 333. Since each of the pixels of the color liquid crystal display module structure according to the present invention comprises only two sub-pixels, on the one hand, the aperture ratio of the pixels is increased and the light transmission rate is made higher so as to achieve a purpose of enhancing the resolution and color saturation of the liquid crystal display module and, on the other hand, the manufacture process of the liquid crystal display panel is simplified so as to improve the productivity of the liquid crystal display module.

The backlight module 1 comprises a light guide plate 11, an optical film assembly 19 arranged on an upper surface of the light guide plate 11, a bottom reflector plate 17 arranged on a lower surface of the light guide plate 11, and a light-emitting diode (LED) light source 13 arranged at one side of the light guide plate 11.

As shown in FIG. 3, the LED light source 13 comprises a plurality of alternately arranged first LED lights 131 and second LED lights 133. The first LED lights 131 each use a blue chip in combination with green phosphor packaging (B+G phosphor) and the second LED lights 133 each use a blue chip in combination with red phosphor packaging (B+R phosphor). The plurality of first LED lights 131 and second LED lights 133 helps prevent mixing and packaging red and green phosphors in the same LED light that leads to lowering of efficiency due to the red phosphor absorbing green light. Further, both the first and second LED lights 131, 133 use blue chips so that there would be no such problems of inconsistency of driving voltage and inconsistent deterioration of lifespan among the LED lights.

Specifically, each of the first LED lights 131 is spaced from one of the second LED lights 133 that is adjacent thereto by a spacing distance L that is smaller than or equal to 12 mm.

The plurality of first LED lights 131 and second LED lights 133 can be lit alternately.

When the first LED lights 131 are lit and the second LED lights 133 are shut down, the lights transmitting through the yellow and blue color filter units 331, 333 are respectively green light and blue light, which make up a first color field. When the second LED lights 133 are lit and the first LED lights 131 are shut down, the lights transmitting through the yellow and blue color filter units 331, 333 are respectively red light and blue light, which make up a second color field. Through mixture of the first and second color fields, image messages of the three colors of blue, green, and red are quickly displayed, in a time division manner, on the liquid crystal display panel 3 so that through visual persistence of human eyes, an image of full color can be displayed on the eye retinas through accumulation and addition of the three primary colors by application of time color mixing.

It is noted here that the backlight module 1 may further comprise an optical light mixture assembly 15. The optical light mixture assembly 15 is arranged between the light guide plate 11 and the LED light source 13. Since a short period of response time is needed for lighting or shutting down the first and second LED lights 131, 133, at the very moment when the first LED lights 131 are being lit and the second LED lights 133 are being shut down or at the very moment when the second LED lights 133 are being lit and the first LED lights 131 are being shut down, there may be occurrence that both the first and second LED lights 131, 133 are ON. The optical light mixture assembly 15 allows the lights emitting from the first and second LED lights 131, 133 at the slim moment when they are both ON to be mixed to form white light.

On the basis of the above-described color liquid crystal display module structure, the present invention further provides a backlight module. With simultaneous reference to FIGS. 2 and 3, the backlight module 1 comprises a light guide plate 11, an optical film assembly 19 arranged on an upper surface of the light guide plate 11, a bottom reflector plate 17 arranged on a lower surface of the light guide plate 11, and an LED light source 13 arranged at one side of the light guide plate 11.

Importantly, the LED light source 13 comprises a plurality of alternately arranged first LED lights 131 and second LED lights 133. The first LED lights 131 each use a blue chip in combination with green phosphor packaging (B+G phosphor) and the second LED lights 133 each use a blue chip in combination with red phosphor packaging (B+R phosphor). The plurality of first LED lights 131 and second LED lights 133 helps prevent mixing and packaging red and green phosphors in the same LED light that leads to lowering of efficiency due to the red phosphor absorbing green light. Further, both the first and second LED lights 131, 133 use blue chips so that there would be no such problems of inconsistency of driving voltage and inconsistent deterioration of lifespan among the LED lights.

The plurality of the first LED lights 131 and the second LED lights 133 can be lit alternately to allow the color liquid crystal display module to achieve two field sequential displaying.

Specifically, each of the first LED lights 131 is spaced from one of the second LED lights 133 that is adjacent thereto by a spacing distance L that is smaller than or equal to 12 mm.

The backlight module 1 may further comprise an optical light mixture assembly 15. The optical light mixture assembly 15 is arranged between the light guide plate 11 and the LED light source 13 to allow the lights emitting from the first and second LED lights 131, 133 at a moment when they are both ON to be mixed to form white light.

In summary, the present invention provides a color liquid crystal display module structure, which has pixels each comprise two sub-pixels. The sub-pixels respectively correspond to yellow and blue color filter units of a CF substrate. An LED light source comprises a plurality of alternately arranged first LED lights and second LED lights, so that when the first LED lights are lit and the second LED lights are shut down, green and blue lights are emitted to make up a first color field; and when the second LED lights are lit and the first LED lights are shut down, red and blue lights are emitted to make up a second color field. The first and second color fields are mixable to achieve displaying an image in full color. Further, the aperture ratio is made greater and the light transmission rate is increased so that the liquid crystal display module has high resolution, high gamut, and high efficiency and the productivity of liquid crystal display module can be enhanced. The present invention provides a backlight module, which comprises an LED light source that comprises a plurality of alternately arranged first LED lights that use a blue chip in combination with green phosphor packaging and second LED lights that use a blue chip in combination with red phosphor packaging. The first and second LED lights are lit alternately to allow a color liquid crystal display module to achieve two field sequential displaying thereby increasing the efficiency of the LED lights and preventing the problems of inconsistency of driving voltage and inconsistent deterioration of lifespan of the LED lights.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A color liquid crystal display module structure, comprising a backlight module and a liquid crystal display panel arranged above the backlight module, the liquid crystal display panel comprising a color filter (CF) substrate, the CF substrate comprising a plurality of alternately arranged yellow color filter units and blue color filter units, the liquid crystal display panel comprising a plurality of pixels arranged in a matrix form, each of the pixels comprising two sub-pixels, the sub-pixels respectively corresponding to the yellow and blue color filter units, the backlight module comprising a light-emitting diode (LED) light source, the LED light source comprising a plurality of alternately arranged first LED lights and second LED lights, the first LED lights each using a blue chip in combination with green phosphor packaging, the second LED lights each using a blue chip in combination with red phosphor packaging, the first and second LED lights being alternately lit.

2. The color liquid crystal display module structure as claimed in claim 1, wherein when the first LED lights are lit and the second LED lights are shut down, lights transmitting through the yellow blue color filter units are respectively green light and blue light, which make up a first color field; and when the second LED lights are lit and the first LED lights are shut down, lights transmitting through the yellow and blue color filter units are respectively red light and blue light, which make up a second color field; and the first and second color fields are mixable to achieve displaying an image with full color.

3. The color liquid crystal display module structure as claimed in claim 1, wherein each of the first LED lights is spaced from one of the second LED lights that is adjacent thereto by a spacing distance L that is smaller than or equal to 12 mm.

4. The color liquid crystal display module structure as claimed in claim 1, wherein the backlight module further comprises a light guide plate, an optical film assembly arranged on an upper surface of the light guide plate, and a bottom reflector plate arranged on a lower surface of the light guide plate, the LED light source being arranged at one side of the light guide plate.

5. The color liquid crystal display module structure as claimed in claim 4, wherein an optical light mixture assembly is arranged between the light guide plate and the LED light source.

6. The color liquid crystal display module structure as claimed in claim 1, wherein the liquid crystal display panel further comprises a thin-film transistor (TFT) substrate arranged below the CF substrate and a liquid crystal layer arranged between the TFT substrate and the CF substrate.

7. A backlight module, comprising a light-emitting diode (LED) light source, the LED light source comprising a plurality of alternately arranged first LED lights and second LED lights, the first LED lights each using a blue chip in combination with green phosphor packaging, the second LED lights each using a blue chip in combination with red phosphor packaging, the first and second LED lights being alternately lit.

8. The backlight module as claimed in claim 7, wherein each of the first LED lights is spaced from one of the second LED lights that is adjacent thereto by a spacing distance L that is smaller than or equal to 12 mm.

9. The backlight module as claimed in claim 7 further comprising a light guide plate, an optical film assembly arranged on an upper surface of the light guide plate, and a bottom reflector plate arranged on a lower surface of the light guide plate, the LED light source being arranged at one side of the light guide plate.

10. The backlight module as claimed in claim 9, wherein an optical light mixture assembly is arranged between the light guide plate and the LED light source.

11. A backlight module, comprising a light-emitting diode (LED) light source, the LED light source comprising a plurality of alternately arranged first LED lights and second LED lights, the first LED lights each using a blue chip in combination with green phosphor packaging, the second LED lights each using a blue chip in combination with red phosphor packaging, the first and second LED lights being alternately lit;
wherein each of the first LED lights is spaced from one of the second LED lights that is adjacent thereto by a spacing distance L that is smaller than or equal to 12 mm;
the backlight module further comprising a light guide plate, an optical film assembly arranged on an upper surface of the light guide plate, and a bottom reflector plate arranged on a lower surface of the light guide plate, the LED light source being arranged at one side of the light guide plate; and
wherein an optical light mixture assembly is arranged between the light guide plate and the LED light source.
